(19) United States
(12) Patent Application Publication
(10) Pub. No.: US 2004/0258997 A1
(43) Pub. Date: Dec. 23, 2004

(54) Negative electrode for secondary cell,secondary cell, and method for producing negative electrode for secondary cell

(76) Inventors: Koji Utsugi, Tokyo (JP); Hironori Yamamoto, Tokyo (JP); Jiro Iriyama, Tokyo (JP); Mitsuhiro Mori, Tokyo (JP); Tamaki Miura, Tokyo (JP); Yutaka Bannai, Tokyo (JP); Mariko Miyachi, Tokyo (JP); Ikiko Yamazaki, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 10/493,487

(22) PCT Filed: Feb. 25, 2003
(86) PCT No.: PCT/JP03/02060

(30) Foreign Application Priority Data
Feb. 26, 2002 (JP) 2002-50536

(51) Int. Cl. H01M 4/62; H01M 4/58; B05D 5/12; B05D 1/36

(52) U.S. Cl. 429/232; 429/218.1; 429/231.95; 427/122; 427/404; 427/419.2

(57) ABSTRACT

A multilayer negative electrode having a carbon layer as a first layer, realizing high battery capacity in the range of voltages at which a battery is actually used while maintaining high charge/discharge efficiency and good cycle characteristics by a simple method. A first layer (2a) the major component of which is carbon and a second layer (3a) the major component of which is filmy material having lithium ion conductivity are stacked on copper foil (1a). The second layer (3a) is formed by dispersing at least one kind of metal particles, alloy particles, and metal oxide particles in a solution in which a binder is dissolved and applying and drying the coating solution.

### TECHNICAL FIELD

The present invention relates to a negative electrode for a secondary battery, a secondary battery, and a method for producing a negative electrode for a secondary battery.

### BACKGROUND ART

With widespread use of mobile terminals such as cellular phones and laptop personal computers, the role of secondary batteries, which serve as a power supply for such mobile terminals, has gained recognition. These secondary batteries for terminals are required to be small/light, and also to have high capacity and the property that they are not easily deteriorated even when they are discharged and recharged many times.

Examples of the secondary batteries include a lithium ion secondary battery, for the negative electrode of which, carbon materials such as graphite and hard carbon capable of absorbing and emitting lithium ions are in practical use in view of high energy density, good charge and discharge cycle characteristics, and high-security. However, the capacity of the existing lithium ion secondary batteries is insufficient to satisfy the demand of high-capacity and high-speed communications by cellular phones, etc. and high-speed communications of color images and the like. Therefore, there is need for a further increase in the energy density of the negative electrode.

A variety of approaches have been made in order to increase the capacity of the negative electrode of the lithium ion secondary battery using carbon material as a base. For example, in Japanese Patent Application laid open No. HEI9-259868, there is disclosed a technique for increasing capacity by adding aluminum, lead and silver being small in particle diameter to the carbon material as adjuvant to help the absorption and emission of Li ions. Besides, in Republication Patent No. WO96/33519, there is disclosed a technique for utilizing metal oxide that contains Sn or the like as material for the negative electrode. By adding/mixing the metal or metal oxide to/with the carbon material for the negative electrode, it is believed that the high-capacity negative electrode having a good cycle characteristic can be obtained. According to the technique disclosed in Japanese Patent Application laid open No. HEI9-259868, in which aluminum, etc. being small in particle diameter is added to the carbon materials, it is difficult to disperse metal particles uniformly in the carbon material. As a result of localization of metal in the negative electrode, electric fields are localized when a charge/discharge cycle has been repeated, and the charging/discharging state of the negative electrode becomes unsteady. Thus, problems such as the distortion of the negative electrode, the separation of a negative electrode active material from a collector, and the like has arisen. For this reason, it is difficult to maintain a high standard of cycle characteristics. Metal oxide amorphous material, SnBxPyOz (x: 0.4 to 0.6, y: 0.6 to 0.4), which is disclosed in Republication Patent No. WO96/33519, has a problem in that irreversible capacity is large at the first charge/discharge, and it is difficult to sufficiently increase the energy density of a battery.

In addition, these negative electrodes of the prior art have a common problem in that a high operating voltage cannot be obtained. This is because, in the case where metal is mixed with carbonaceous material, a plateau specific to metal is formed at a potential higher than that of carbon on the discharge curve, and therefore, the operating voltage becomes lower as compared to a case where only carbon is utilized as the negative electrode. The lower limit voltage of the lithium ion secondary battery is specified as usage. Consequently, if the operating voltage of the negative electrode is low, the availability or the scope of application of the lithium ion secondary battery is narrowed, and it becomes difficult to increase available capacity.

In order to solve these problems, there has been proposed a negative electrode which is obtained by forming an active material layer made of silicon-based alloy or the like on the surface of a carbon layer through vacuum film forming (Japanese Patent Application laid open No. HEI7-296798, Japanese Patent Application laid open No. HEI7-326342, Japanese Patent Application laid open No. 2001-283833).

### PROBLEMS THAT THE INVENTION IS TO SOLVE

However, the conventional techniques, in which the negative electrode is formed by the vacuum film forming of an active material layer made of silicon-based alloy, etc. over the layer of carbon, present problems as will hereinafter be described.

In the aforementioned layered negative electrode having an active material layer made of silicon-based alloy, etc. over the layer of carbon formed through the vacuum film forming, the carbon layer, which provides the first layer, is generally formed by applying paint or a coating solution made from active material such as graphite, a binder and the like dispersed in an organic solvent to a conductive base substance, and then drying the paint.

When a battery, which is provided with a negative electrode obtained by forming the second layer made of a metal or a semiconductor on the surface of such carbon layer or the first layer through vacuum film forming, is discharged/recharged repeatedly, the second layer flakes off or is pulverized since the expansion and contraction of the second layer is more significant as compared with the first layer, and cycle efficiency is considerably reduced even though the battery initially possesses high capacity.

Further, in the case where a layer of evaporant having a high melting point such as silicon-based alloy is formed on the surface of the carbon layer of the negative electrode by vacuum deposition, radiation heat from an evaporation source is extreme. If the carbon layer of the negative electrode absorbs much of the radiation heat, a binder, etc. contained in the carbon layer is damaged, which may have adverse effects on the charge/discharge cycle characteristic of a battery. In order to suppress the absorption of the radiation heat, it is necessary to take various measures, as for example pouring a cooling medium into a vacuum deposition device or increasing the traveling speed of base material for the negative electrode (copper foil, etc.), which complicates the construction of the device. When increasing the traveling speed of base material for the negative electrode (copper foil, etc.), the effect of the radiation heat can be lessened, however, it becomes difficult to realize a desired film thickness since the amount of the deposit that adheres on the carbon layer is reduced. According to vacuum film-forming methods such as vacuum deposition, CVD and sputtering, a film is formed at a lower speed as compared to conventional coating methods, and therefore, a considerable amount of time has been required to realize a film thickness of some micrometers for the negative electrode.

Furthermore, on the occasion of commercial production, a large amount of active materials adhere to the inside of a chamber of a vacuum deposition device, which causes problems in terms of the process, as for example the chamber needs frequent cleanings. Because of this, it is conceivable that the process yield will be decreased in view of the characteristics of a battery.

For the above reason, in order to achieve the stable cycle characteristic of the lithium ion secondary battery, it is highly important to select material and a production method such that the expansion and contraction of the second layer of the negative electrode are suppressed as much as possible.

It is therefore an object of the present invention to achieve high battery capacity while maintaining high charge/discharge efficiency and good cycle characteristics through a simple method in consideration of the problems with the layered negative electrode of the prior art obtained by forming a thin film layer of a metal or a semiconductor over the layer of carbon.

### DISCLOSURE OF THE INVENTION

In accordance with the present invention, there is provided a negative electrode for a secondary battery comprising a collector, at least one first layer largely composed of carbon, and at least one second layer largely composed of filmy material having lithium ion conductivity, which are laminated in this order, wherein the second layer is formed of one or more kinds of particles selected from metal particles, alloy particles and metal oxide particles being bound by a binder.

Further, in accordance with the present invention, there is provided a method for producing a negative electrode for a secondary battery comprising a collector, at least one first layer largely composed of carbon, and at least one second layer largely composed of filmy material having lithium ion conductivity, which are laminated in this order, comprising the steps of forming the first layer largely composed of carbon on the collector, and forming the second layer by coating the first layer with paint or a coating solution that contains one or more kinds of particles selected from metal particles, alloy particles and metal oxide particles and a binder, which is then dried.

Still further, in accordance with the present invention, there is provided a secondary battery comprising at least a negative electrode for a secondary battery, a positive electrode capable of absorbing and emitting lithium ions, and an electrolytic solution present in between the negative electrode and the positive electrode.

According to the present invention, in the construction of the negative electrode, one or more kinds of particles selected from metal particles, alloy particles and metal oxide particles are bound by a binder. Therefore, the second layer adheres firmly to the first layer, and the mechanical strength of a multilayer film is improved.

Preferably, the average diameter of the metal particles, alloy particles and metal oxide particles contained in the second layer is not more than 80% of the thickness of the second layer in view of the accuracy of film thickness control. With this, the film thickness can be suitably controlled, and the generation of irregularities on the surface of the second layer can be suppressed. The generation of irregularities is particularly noticeable when, for example, the film thickness is 5 μm or less. If there are major irregularities, the damage to a separator is increased, which may consequently cause a short circuit to the positive electrode. Besides, in the case of forming a third layer made of lithium or the like on the second layer, which will hereinafter be described, by vacuum film forming, if there are major irregularities, it becomes difficult to form a film having a uniform thickness, and irregularities of the third layer are increased. When there are major irregularities in the layer that is made of a highly active substance such as lithium, that is, a number of random active points exist, dendrite is easily formed. As a result, a short circuit is more likely to take place by repetition of charging and discharging, and safety problems arise.

In the case where metal particles are contained in the second layer, the metal particles preferably contain one or more elements selected from a group of Si, Ge, Sn, In and Pb from the perspective that the theoretical active material energy density is high, lithium ions are conducted easily, they can be dispersed into the binder and the like.

The alloy particles contained in the second layer preferably contain as their constituents one or more elements selected from a group of Si, Ge, Sn, In and Pb, more specifically, a Li:Si alloy, a Li:Ge alloy, a Li:Sn alloy, a Li:In alloy and a Li:Pb alloy.

In the case where metal oxide particles are contained in the second layer, the metal oxide particles preferably contain one or more materials selected from a group of metal oxides made from Si, Ge, Sn, In and Pb from the perspective that the theoretical active material energy density is high, lithium ions are conducted easily, they can be dispersed into the binder and the like.

The above described metal particles, etc. may be utilized as elemental substances not including carbon or the like, and also may be coated with a carbonaceous layer, or a metal layer may be coated on the surfaces of carbonaceous particles, appropriately.

The particles which form the second layer may be mainly composed of any of metal particles, alloy particles and metal oxide particles. “Mainly” indicates that such particles constitute, for example, 80%, by mass, of the entire particles contained in the second layer. According to the present invention, it is desirable in the interest of initial capacity and the like that the particles which form the second layer be mainly composed of metal particles. On the other hand, it is desirable in the interest of the cycle characteristics and the like that the particles which form the second layer be mainly composed of metal oxide particles.

The negative electrode for a secondary battery of the present invention may employ a construction in which a third layer having lithium ion conductivity is formed on the second layer. With this construction, initial capacity can be improved.

The negative electrode for a secondary battery of the present invention may have a construction in which the first layer is formed of carbonaceous materials being bound by a binder, and both the binders contained in the first layer and the second layer are fluorocarbon resin. When such construction is adopted, stress caused by expansion and contraction associated with the absorption/emission of lithium can be reduced since both the binders contained in the respective first layer and second layer are fluorocarbon resin, and the flaking and pulverization of the negative electrode can be effectively suppressed.

According to the present invention, the paint or the coating solution may be coated by any of such means as an extrusion coater, a reverse roller, a doctor blade, etc., and, in the case of forming films in layers, layering techniques such as a concurrent multilayer coating method and a sequential multilayer coating method may be adopted making use of the means in combination appropriately.

In accordance with the present invention, with the use of the negative electrode having a multilayer construction in which the third layer is former on the second layer, it becomes possible to provide a lithium secondary battery having high capacity and excellent charge/discharge cycle characteristics. According to the present invention, the substance that forms the third layer is preferably, but is not limited to so long as it is lithium or chemical compounds containing lithium, metallic lithium, lithium alloy, lithium nitride, Li_{3-X}M_{X}N (M=Co, Ni, Cu; 0≦X≦1) and mixtures of these. Such material is electrochemically capable of emitting a large amount of lithium, and therefore, the charge/discharge efficiency of the battery can be improved while compensating for the irreversible capacity of the negative electrode. Moreover, the second layer made of filmy material having lithium ion conductivity is doped with a part of lithium contained in the third layer, which increases lithium ion density in the second layer and the number of carriers. Consequently, the lithium ion conductivity is further improved. Thereby, the resistance of the battery can be reduced, and the effective capacity of the battery is further improved. In addition, since such ion conducting film is present evenly on the negative electrode, the distribution of electric fields in between the negative and positive electrodes becomes uniform. Therefore, electric fields are not localized, and stable battery characteristics can be obtained even after several cycles without damage such as the separation of active material from a collector.

Further, in accordance with the present invention, the substance that forms the third layer has preferably an amorphous structure. The amorphous structure is structurally equant as compared to crystals and therefore chemically stable, thus hardly inducing a side reaction to an electrolytic solution. For this reason, lithium contained in the third layer can be effectively utilized to compensate for the irreversible capacity of the negative electrode.

Still further, in accordance with the present invention, a fine effect can be achieved by any of vacuum film-forming methods such as vacuum deposition, CVD and sputtering, and wet processes such as coating methods for forming the third layer. With the use of these film-forming methods, an amorphous layer can be formed evenly over the entire negative electrode. Especially, application of vacuum film-forming methods eliminates need for a solvent, and therefore, it becomes possible to form a layer of a high degree of purity, which hardly cause a side reaction. Consequently, lithium contained in the third layer can be effectively utilized to compensate for the irreversible capacity of the negative electrode.

A buffer layer may be provided in between the first layer the major component of which is carbon and the second layer or the third layer. The buffer layer helps to promote adhesive properties among the layers, to adjust lithium ion conductivity and to prevent local electric fields, and may be a thin film containing a metal, metal oxide, carbon, semiconductor or the like.

### BRIEF DESCRIPTION OF THE DRAWINGS

FIG. 1 is a cross-sectional view schematically showing an example of the construction of a negative electrode of a secondary battery according to the first to third examples and the first to third comparative examples of the present invention.

FIG. 2 is a cross-sectional view schematically showing an example of the construction of a negative electrode of a secondary battery according to the fourth to eighth examples and the fourth to sixth comparative examples of the present invention.

FIG. 3 schematically shows an example of copper foil on which patterned graphite layers are formed according to the first to eighth examples and the first to sixth comparative examples of the present invention.

FIG. 4 schematically shows an example of copper foil in the case where patterned second layers 3a are formed on the patterned graphite layers according to the first to third examples and the first to third comparative examples of the present invention.

FIG. 5 schematically shows an example of the construction of a vacuum deposition device for forming the second layers 3a and third layers 4a of a negative electrode of a secondary battery according to the first to sixth comparative examples and the fourth to eighth examples of the present invention.

FIG. 6 schematically shows an example of copper foil in the case where the patterned second layers 3a and patterned third layers 4a are formed on the patterned graphite layers according to the fourth to eighth examples and the fourth to sixth comparative examples of the present invention.

Incidentally, the reference numeral 1a represents copper foil. The reference numeral 2a represents first layers. The reference numeral 3a represent second layers. The reference numeral 4a represents third layers. The reference numeral 5 represents an unwinding roller. The reference numeral 6 represents a winding roller. The reference numeral 7 represents a position detector. The reference numeral 8 represents can rolls. The reference numeral 9 represents a movable mask. The reference numeral 10 represents an evaporation source. The reference numeral 11 represents a vacuum exhauster. The reference numeral 12 represents a gas supply valve. The reference numeral 20 represents copper foil.

### BEST MODE FOR CARRYING OUT THE INVENTION

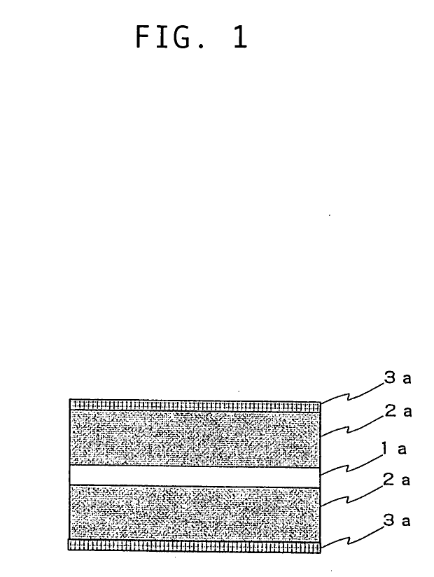

FIG. 1 is a cross-sectional view of a negative electrode of a nonaqueous electrolyte secondary battery according to the present invention, and shows an example of the case where the negative electrode layers includes first layers 2a and second layers 3a.

Copper foil 1a that provides a collector acts as an electrode for letting current out of the battery and drawing current into the battery from the outside on the occasion of charging/discharging. The collector is only required to be conductive metal foil and, in addition to copper, for example, aluminum, stainless steel, gold, tungsten, molybdenum, etc. may be employed.

A carbon negative electrode being the first layer 2a is a negative electrode member that absorbs or emits Li on the occasion of charging/discharging. The carbon negative electrode is made of carbon capable of absorbing Li, and graphite, fullerene, carbon nanotube, DLC (Diamond Like Carbon), amorphous carbon, hard carbon and mixtures of these may be cited as examples.

The second layer 3a is a negative electrode member having lithium ion conductivity, and is formed by mixing one or more kinds of metal particles, alloy particles and metal oxide particles with at least a binder through the use of a solvent or a dispersion liquid so that they are dispersed, and applying and drying the coating solution or paint. As examples of the negative electrode member having lithium ion conductivity may be cited silicon, tin, germanium, lead, indium, boron oxide, phosphorus oxide, aluminum oxide, composite oxides of these, and the like, which may be used either singularly or in combination. Besides, lithium, lithium halide, lithium chalcogenide, etc. may be added to them to increase lithium ion conductivity. An electronic conduction adjuvant (conductivity applicator) may be added to the second layer to render it conductive. Examples of the electronic conduction adjuvant include, but are not limited to, metal powder such as aluminum powder, nickel powder and copper powder, and carbon powder which is generally utilized for batteries. That is, powdered materials having good electric conductivity may be used. Examples of the binder for the second layer include, but are not limited to, polyvinyl alcohol, ethylene/propylene/diene ternary copolymer, styrene/butadiene rubber, polyvinylidene fluoride (PVDF), polytetrafluoroethylene, tetrafluoroethylene-hexafluoropropylene copolymer and the like.

While the first carbon negative electrode layers and the second negative electrode layers are formed on the both sides of the collector in FIG. 1, according to the present invention, the negative electrode layers may be formed on only one side of the collector.

Besides, when the negative electrode layers are formed on the both sides, the negative electrodes on the respective sides are not necessarily made of the same material and do not necessarily have the same construction.

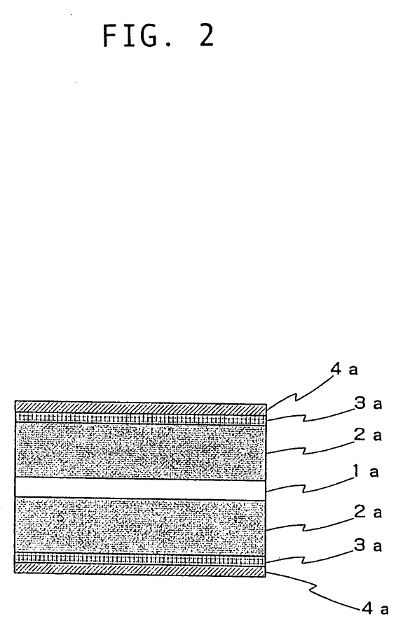

FIG. 2 shows an example of the construction of a negative electrode in the case where third layers 4a are formed on the second layers 3a.

The third layer 4a is a negative electrode member made of lithium or chemical compounds containing lithium. As examples of such material may be cited metallic lithium, lithium alloy, lithium nitride, Li_{3-X}M_{X}N (M=Co, Ni, Cu; 0≦X≦1) and mixtures of these, which may be used either singularly or in combination.

While the first carbon negative electrode layers, the second layers 3a and the third layers 4a are formed on the both sides of the collector in FIG. 2, according to the present invention, the negative electrode layers may be formed on only one side of the collector. Additionally, when the negative electrode layers are formed on the both sides, the negative electrodes on the respective sides are not necessarily made of the same material and do not necessarily have the same construction.

A positive electrode available for the lithium secondary battery of the present invention may be formed in such a manner that composite oxides Li_{X}MO₂ (M indicates at least one transition metal), for example, Li_{X}CoO₂, Li_{X}NiO₂, Li_{X}Mn₂O₄, Li_{X}MnO₃, Li_{X}NiyC_{1-y}O₂ or the like, a conductive substance such as carbon black and a binder such as polyvinylidene fluoride (PVDF) are dispersed and mixed in a solvent or a dispersion liquid such as N-methyl-2-pyrrolidone (NMP), and the mixture is applied over a base substance such as aluminum foil.

Besides, as a separator available for the lithium secondary battery of the present invention, a porous film made of polyolefin such as polypropylene and polyethylene, fluorocarbon resin, and the like may be utilized.

An electrolytic solution is prepared by dissolving lithium salts in an aprotic organic solvent. Examples of the organic solvent include: ring carbonates such as propylenecarbonate (PC), ethylenecarbonate (EC), butylenecarbonate (BC), and vinylenecarbonate (VC); chain carbonates such as dimethylcarbonate (DMC), diethylcarbonate (DEC), ethylmethylcarbonate (EMC), and dipropylcarbonate (DPC); aliphatic carboxylic acid esters such as methyl formate, methyl acetate, ethyl propionate; γ-lactones such as γ-butyrolactone; chain ethers such as 1,2-diethoxyethane (DEE) and ethoxymethoxyethane (EME); ring ethers such as tetrahydrofuran and 2-methyltetrahydrofuran; dimethylsulfoxide; 1,3-dioxolane; formamide; acetamide; dimethylformamide; dioxolane; acetonitrile; propylnitrile; nitromethane; ethylmonoglyme; triester phosphate; trimethoxymetane; dioxolane derivatives; sulfolane; methylsulfolane; 1,3-dimethyl-2-imidazolidinone; 3-methyl-2-oxazolidinone; propylenecarbonate derivatives; tetrahydrofuran derivatives; ethyl ether, 1,3-propanesultone; anisole; and N-methylpyrrolidone, which may be used either individually or in mixtures of two or more kinds. As examples of the lithium salts dissolved in the organic solvents may be cited LiPF₆, LiAsF₆, LiAlCl₄, LiClO₄, LiBF₄, LiSbF₆, LiCF₃SO₃, LiCF₃CO₂, Li (CF₃SO₂)₂, LiN (CF₃SO₂), LiB₁₀Cl₁₀, lower aliphatic lithium carboxylate, lithium chloroborane, 4-lithium phenyl borate, LiBr, LiI, LiSCN, LiCl and imides. In addition, a polymer electrolyte may be used as a substitute for the electrolytic solution.

Examples of the shape of the battery include, but are not limited to, cylinder types, square types, and coin types. Also, there are imposed no particular limitations upon the exterior package of the battery, and, for example, a metal case, laminated metal and the like may be used.

### EXAMPLE 1

By Example 1, the present invention will be more fully described. A battery in this Example is of the same construction as that shown in FIG. 1, and comprises first layers 2a and the second layers 3a, which are laminated on copper foil 1a that provides a collector. Graphite was utilized as the major component of carbon negative electrodes of the first layers 2a. The second layers were mainly composed of Si powder dispersed in a binder, and formed by a coating method. In the following, a method for producing the battery will be described.

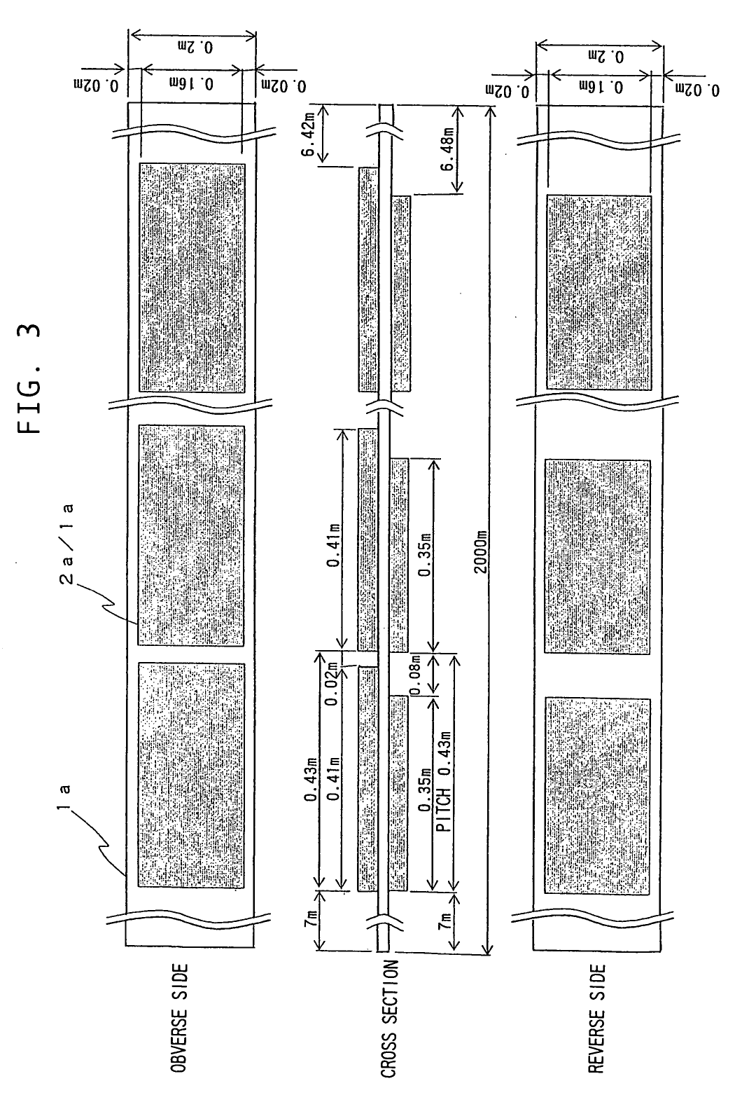

First, as can be seen in FIG. 3, the first layers 2a made of graphite were deposited in a thickness of about 50 μm on copper foil 20 of about 2000 m in length and 10 μm in thickness, which was employed as a negative electrode collector being a flexible support. The first layers 2a made of graphite were formed in such a way that graphite powder were mixed with polyvinylidene fluoride dissolved in N-methyl-2-pyrrolidone as a binder and conductive adjuvant to make a paste, and the paste was applied over the both sides of the copper foil by the coating method with the use of a doctor blade. FIG. 3 shows patterns of graphite-coated parts. The obverse side of the copper foil was provided with uncoated parts of 7 m and 6.42 m at the left end part and the right end part, respectively. The graphite-coated parts were formed from a position spaced 7 m from the left end in 0.16 m width at a lengthwise pitch of 0.43 m (coated part: 0.41 m, space: 0.02 m), and there were 4620 graphite-coated parts. On the other hand, the reverse side of the copper foil was provided with uncoated parts of 7 m and 6.48 m at the left end part and the right end part, respectively. The graphite-coated parts were formed from a position spaced 7 m from the left end at a pitch of 0.43 m (coated part: 0.35 m, space: 0.08 m), and there were 4620 graphite-coated parts.

The second layers 3a mainly composed of silicon were formed in a thickness of about 3 μm on the first layers made of carbon by the coating method with the use of a doctor blade. Si powder, the average particle diameter of which was 1 μm, and conductive adjuvant were dispersed and mixed in polyvinylidene fluoride dissolved or dispersed in N-methyl-pyrrolidone to prepare paint or a coating solution, and thereafter, the coating solution was applied over the first layers 2a composed of the graphite layers in the same manner as above, and then dried at 130° C.

Next, negative electrodes were cut out from the copper foil on which the negative electrode layers had been formed so that each of them had a width of 0.04 m and an elongated length of 0.43 m (obverse side coated part: 0.41 m, obverse side uncoated part: 0.02 m, reverse side coated part: 0.35 m, reverse side uncoated part: 0.08 m). Thereby, 4620×4 negative electrodes were obtained. The second layers containing Si could be formed evenly (in the same film thickness) over the entire graphite layers (the first layers 2a). The uncoated parts were utilized as terminal extracting parts. Thus, the layered negative electrode utilized in Example 1 was produced.

These negative electrodes were combined with positive electrodes, which had been obtained by dispersing and mixing lithium cobaltate, conductive adjuvants, polyvinylidene fluoride, etc. in N-methyl-2-pyrrolidone and applying the mixture over aluminum foil, to produce a wound cell (battery) with a laminated (aluminum) exterior package.

Incidentally, polypropylene nonwoven cloth was used for a separator. Besides, an electrolytic solution was a mixed solvent mainly containing ethylenecarbonate (EC) and diethylcarbonate (DEC) (EC/DEC mixture ratio: 30 to 70 by volume), in which 1 mol/L of LiPF₆ was dissolved.

Charge/discharge cycle tests were carried out for the battery with the negative electrode produced in Example 1. In the charge/discharge test, the range of voltages was set at 3 to 4.3V. Results of the tests are shown in Table 1 (comparative examples are shown in Table 2). The initial charge/discharge efficiency in Example 1 is 90.1%, while that in Comparative Example 1 is 82.6%. From the results, it is understood that the initial charge/discharge efficiency in Example 1 is high as compared to Comparative Example 1 in which the second layers (Si) were formed by vacuum deposition.

Assuming that discharge capacity for 1 cycle or in the first cycle, expressed as a percentage, is 100%, the ratio of discharge capacity for 500 cycles or in the 500th cycle thereto (C500/C1 discharge capacity ratio) exceeds 80%, that is, the discharge capacity is maintained at over 80% of the initial capacity even after the 500th cycle, and is far better than that of Comparative Example 1 (51.5%). One conceivable reason why Example 1 achieved better charge/discharge efficiency and cycle characteristics as compared to Comparative Example 1 is because, in Example 1, the binder (PVDF) which was present in the first layers 2a was not damaged by heat, and therefore, a deterioration in adhesion to the collector and decomposition or degradation of the binder itself were prevented. Another conceivable reason is that the second layers 3a adhered firmly to the first layers 2a by the adhesive action of the binder contained in the second layers 3a and did not easily flake off, and separation and pulverization due to expansion and contraction were suppressed.

In regard to the net film-forming time (the time required for both side coating), it took about 2.7 hours to form the second layers 3a over the copper foil of 2000 m long. This is much less than the film-forming time (the time required for both side deposition: 67 hours) in Comparative Example 1. Consequently, when films were formed over copper foil of 2000 m long in Example 1, the time required for the production of the negative electrodes (the second layers 3a) was reduced to about one twenty-fifth.

The evaluation results in Example 1 proves that the secondary battery provided with the negative electrode according to the present invention permits substantial reductions in the time taken to produce the negative electrodes in mass production and achieves high initial charge/discharge efficiency with stable cycle characteristics.

TABLE 1

| | Example 1 | Example 2 | Example 3 |
|---|---|---|---|
| Initial Charge Capacity | 0.956 Ah | 1.052 Ah | 0.915 Ah |
| Initial Discharge Capacity | 0.861 Ah | 0.972 Ah | 0.815 Ah |
| Initial Charge/Discharge Efficiency | 90.1% | 92.4% | 89.1% |
| Discharge Capacity Ratio (C500/C1) | 80.1% | 84.3% | 80.0% |

### EXAMPLE 2

Negative electrodes were produced in the same manner as in Example 1 except that an active material contained in the second layers 3a was Li:Si alloy, and battery characteristics were evaluated. Test results are shown in Table 1. The initial charge/discharge efficiency in Example 2 is 92.4%, while that in Comparative Example 2 is 84.4%. From the results, it is understood that the initial charge/discharge efficiency in Example 2 is high as compared to Comparative Example 2 in which the second layers 3a (Li:Si alloy) were formed by vacuum deposition.

Assuming that discharge capacity for 1 cycle, expressed as a percentage, is 100%, the ratio of discharge capacity for 500 cycles thereto (C500/C1 discharge capacity ratio) exceeds 80%, that is, the discharge capacity is maintained at over 80% of the initial capacity even after the 500th cycle, and is far better than that of Comparative Example 2 (57.1%). One conceivable reason why Example 2 achieved better charge/discharge efficiency and cycle characteristics as compared to Comparative Example 2 is because, in Example 2, the binder (PVDF) which was present in the first layers 2a was not damaged by heat, and therefore, a deterioration in adhesion to the collector and decomposition of the binder itself were prevented. Another conceivable reason is that the second layers 3a adhered firmly to the first layers 2a by the adhesive action of the binder contained in the respective first layers 2a and second layers 3a and did not easily flake off, and separation and pulverization due to expansion and contraction were suppressed.

In regard to the net film-forming time (the time required for both side coating), it took about 2.7 hours to form the second layers 3a over the copper foil of 2000 m long. This is much less than the film-forming time (the time required for both side deposition: 67 hours) in Comparative Example 2. Consequently, when films were formed over copper foil of 2000 m long in Example 2, the time required for the production of the negative electrodes (the second layers 3a) was reduced to about one twenty-fifth.

The evaluation results in Example 2 proves that the secondary battery provided with the negative electrode according to the present invention permits substantial reductions in the time taken to produce the negative electrodes in mass production and achieves high initial charge/discharge efficiency with stable cycle characteristics.

### EXAMPLE 3

Negative electrodes were produced in the same manner as in Example 1 except that an active material contained in the second layers 3a was SiO_{X}, and battery characteristics were evaluated. Test results are shown in Table 1.

The initial charge/discharge efficiency in Example 3 is 89.1%, while that in Comparative Example 3 is 74.3%. From the results, it is understood that the initial charge/discharge efficiency in Example 3 is high as compared to Comparative Example 3 in which the second layers 3a (SiO_{X}) were formed by vacuum deposition.

Assuming that discharge capacity for 1 cycle, expressed as a percentage, is 100%, the ratio of discharge capacity for 500 cycles thereto (C500/C1 discharge capacity ratio) exceeds 80%, that is, the discharge capacity is maintained at over 80% of the initial capacity even after the 500th cycle, and is far better than that of Comparative Example 3 (breakdown after the 220th cycle). One conceivable reason why Example 3 achieved better charge/discharge efficiency and cycle characteristics as compared to Comparative Example 3 is because, in Example 3, the binder (PVDF) which was present in the first layers 2a was not damaged by heat, and therefore, a deterioration in adhesion to the collector and decomposition of the binder itself were prevented. Another conceivable reason is that the second layers 3a adhered firmly to the first layers 2a by the adhesive action of the binder contained in the respective first layers 2a and second layers 3a and did not easily flake off, and separation and pulverization due to expansion and contraction were suppressed.

In regard to the net film-forming time (the time required for both side coating), it took about 2.7 hours to form the second layers 3a over the copper foil of 2000 m long. This is much less than the film-forming time (the time required for both side deposition: 67 hours) in Comparative Example 3. Consequently, when films were formed over copper foil of 2000 m long in Example 3, the time required for the production of the negative electrodes (the second layers 3a) was reduced to about one twenty-fifth.

The evaluation results in Example 3 proves that the secondary battery provided with the negative electrode according to the present invention permits substantial reductions in the time taken to produce the negative electrodes in mass production and achieves high initial charge/discharge efficiency with stable cycle characteristics.

### COMPARATIVE EXAMPLE 1

In Comparative Example 1, layered negative electrodes were produced by forming Si layers (the second layers 3a) through vacuum deposition over copper foil that provides a collector (FIG. 3), on which the same carbon negative electrodes as those in Example 1 had been formed.

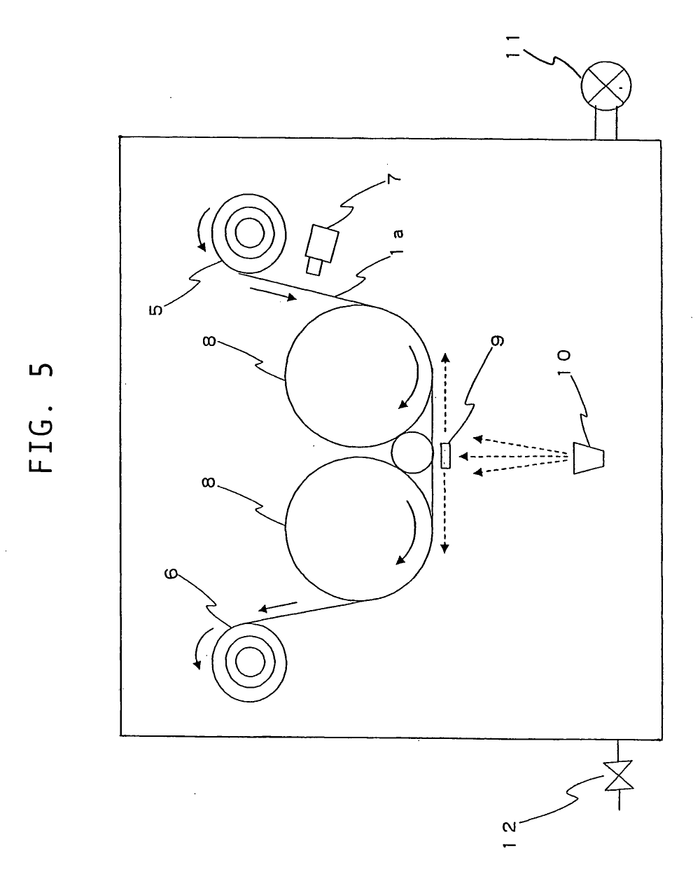

FIG. 5 schematically shows the construction of a vacuum deposition device employed in Comparative Example 1. The vacuum deposition device basically comprises a mechanism for the travel of copper foil 1a and the moving mechanism of a movable mask 9, which is provided to form non-deposited parts utilized for extracting the copper foil 1a and terminals. The movable mask 9 has a width of 2 cm for the obverse side of the copper foil 1a and a width of 8 cm for the reverse side. The vacuum deposition device further comprises, for the operation from winding off to rolling up the copper foil 1a, an unwinding roller 5 for winding off the copper foil 1a, can rolls 8 for assuring effective contact between the copper foil 1a fed from the unwinding roller 5 and the movable mask 9 and improving the accuracy of deposition performed while synchronizing movements between them, and a winding roller 6 for rolling up the copper foil 1a sent from the can rolls 8.

In addition, the vacuum deposition device is provided with a position detector 7 in between the unwinding roller 5 and the can rolls 8 for detecting non-deposited parts accurately in vacuum so that patterning by the movable mask 9 can be carried out with precision. The distance between an evaporation source 10 and the bottoms of the can rolls 8 was set at 25 cm. The movable mask 9 and the copper foil 1a were arranged so that there was a space of no more than 1 mm between them. On the occasion of deposition, the movable mask 9 moves (from right to left in the drawing) in synchronism with the movement of the copper foil 1a so as to mask a non-deposited part. When deposition for first one pitch has been completed, the movable mask 9 moves back (from left to right in the drawing) so as not to block out evaporant, and is set to shield a non-deposited part in the second electrode pitch. By repetitions of this operation, it is possible to define a pattern in the entire graphite layer through vacuum deposition.

First, a Si layer (3 μm thick) was applied in a pattern over a patterned graphite layer on the obverse side of the copper foil 1a by vacuum deposition. In its initial setting condition, the copper foil 1a, which had been prepared in advance, was fitted on the unwinding roller 5 shown in FIG. 5. The copper foil 1a was moved along the can rolls 8, and the edge of the copper foil 1a was set on the winding roller 6. All or part of the rollers were driven to place adequate tension on the copper foil 1a so that the copper foil 1a was appressed against the can rolls 8 above the evaporation source 10 without a sag and a deflection therein. A vacuum exhauster 11 was brought into operation, and a vacuum chamber was evacuated to a pressure of 1×10⁻⁴ Pa. After that, deposition was carried out.

By driving all the rollers, the copper foil 1a was run at an arbitrary speed in synchronism with the movement of the movable mask 9, and Si was continuously evaporated from the evaporation source 10 to form a Si layer over a graphite layer on the obverse side of the copper foil 1a. The copper foil 1a traveled at a rate of 1 m/min, while a film was formed at a deposition rate of 3 μm•m/min. After a film was formed, Ar gas was conducted into the chamber through a gas supply valve 12, and then the chamber was opened to retrieve the copper foil 1a rolled up on the winding roller 6.

Next, a film of an active material composed of Si was formed in a pattern over a patterned graphite layer on the reverse side of the copper foil 1a by vacuum deposition. In its initial setting condition, the copper foil 1a, which had been prepared in advance, was fitted on the unwinding roller 5 shown in FIG. 5. The copper foil 1a was moved along the can rolls 8, and the edge of the copper foil 1a was set on the winding roller 6. All or part of the rollers were driven to place adequate tension on the copper foil 1a so that the copper foil 1a was appressed against the can rolls 8 above the evaporation source 10 without a sag and a deflection therein. After the vacuum exhauster 11 was brought into operation and the vacuum chamber was evacuated to a pressure of 1×10⁻⁴ Pa, deposition was carried out. By driving all the rollers, the copper foil 1a was run at an arbitrary speed in synchronism with the movement of the movable mask 9, and Si was continuously evaporated from the evaporation source to form a Si layer over a graphite layer on the reverse side of the copper foil 1a. After a film was formed, Ar gas was conducted into the chamber through the gas supply valve 12, and then the chamber was opened to retrieve the copper foil 1a rolled up on the winding roller 6.

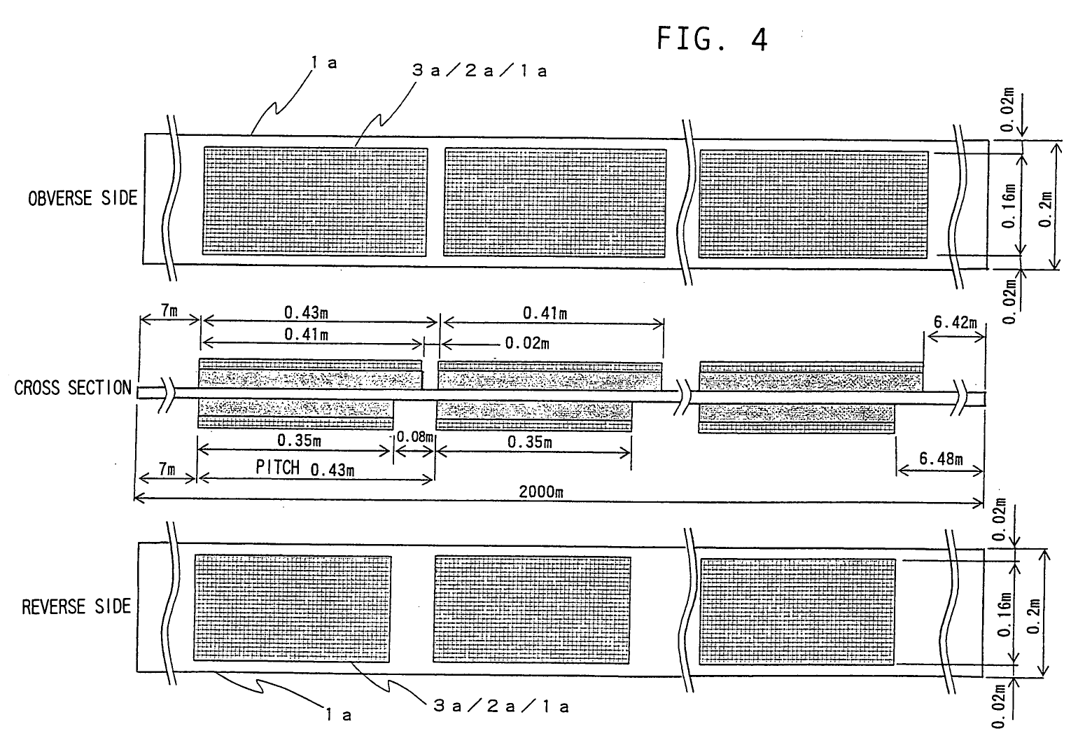

With the use of the negative electrode produced by a vacuum deposition method as described above, a battery having the same construction as that of Example 1 was produced (FIG. 1, FIG. 4). Test results are shown in Table 2. It has been confirmed that Comparative Example 1 provides inferior characteristics as compared to Example 1. Presumably, this is because the binder (PVDF) present in the first layers 2a was damaged by radiant heat on the occasion of vacuum deposition of Si, which caused a deterioration in adhesion to the collector and decomposition of the binder itself. In addition, the flaking and pulverization of the deposited Si layers are incriminated as other causes.

TABLE 2

| | Comparative | Comparative | Comparative |
|---|---|---|---|
| | Example 1 | Example 2 | Example 3 |
| Initial Charge | 0.847 Ah | 0.956 Ah | 0.811 Ah |
| Capacity | | | |
| Initial Discharge | 0.700 Ah | 0.807 Ah | 0.603 Ah |
| Capacity | | | |
| Initial Charge/ | 82.6% | 84.4% | 74.3% |
| Discharge Efficiency | | | |
| Discharge Capacity | 51.5% | 57.1% | breakdown after |
| Ratio (C500/C1) | | | 220 cycles |

### COMPARATIVE EXAMPLE 2

Negative electrodes were produced in the same manner as in Comparative Example 1 except that an active material contained in the second layers 3a was Li:Si alloy, and battery characteristics were evaluated. Test results are shown in Table 2. Presumably, the reason why Comparative Example 2 provides inferior characteristics as compared to Example 2 is because the binder (PVDF) present in the first layers 2a was damaged by radiant heat on the occasion of vacuum deposition of Li:Si alloy, which caused a deterioration in adhesion to the collector and decomposition of the binder itself. In addition, the flaking and pulverization of the deposited Li:Si alloy layers are incriminated as other causes.

### COMPARATIVE EXAMPLE 3

Negative electrodes were produced in the same manner as in Comparative Example 1 except that an active material contained in the second layers 3a was SiO_{X}, and battery characteristics were evaluated. Test results are shown in Table 2. Presumably, the reason why Comparative Example 3 provides inferior characteristics as compared to Example 3 is because the binder (PVDF) present in the first layers 2a was damaged by radiant heat on the occasion of vacuum deposition of SiO_{X}, which caused a deterioration in adhesion to the collector and decomposition of the binder itself. In addition, the flaking and pulverization of the deposited SiO_{X} layers are incriminated as other causes.

### EXAMPLE 4

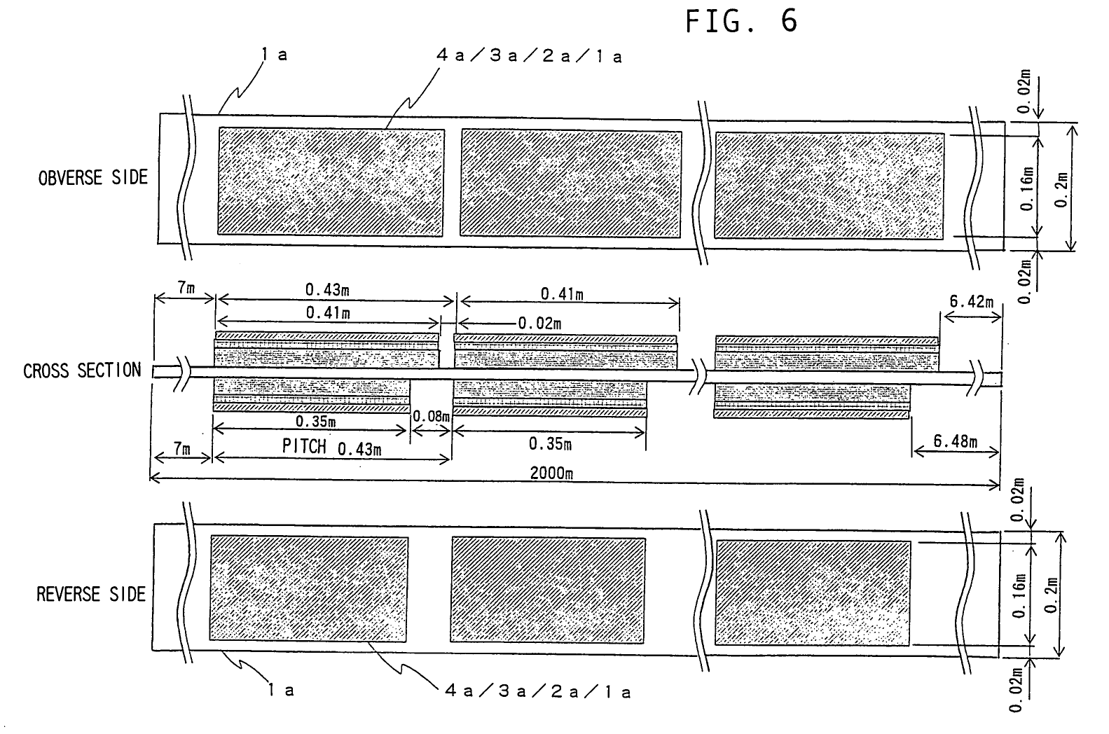

This Example illustrates an example of the negative electrode having a triple-layer construction (FIG. 2, FIG. 6), in which third layers 4a being Li layers are additionally formed on the respective second layers 3a in the construction of the negative electrode described in Example 1. The collector, first layers 2a and second layers 3a were produced from the same materials and in the same manners as in Example 1, respectively.

Copper foil, on which there had been formed up to the second layers 3a of negative electrodes, was set in the vacuum deposition device described in Comparative Example 1, and metal Li was placed as the evaporation source. After that, Li layers or the third layers 4a of 2 μm were formed over the negative electrode layers on the copper foil at a traveling deposition rate of 12 μm•m/min (FIG. 6).

Incidentally, the traveling deposition rate “μm•m/min” indicates the thickness of a film to be formed while the copper foil is run 1 meter a minute. For example, at a traveling deposition rate of “12 μm•m/min”, a film having a thickness of 12 μm is formed while the copper foil is run 1 meter a minute.

Test results are shown in Table 3. The initial charge/discharge efficiency in Example 4 is 93.9%, while that in Comparative Example 4 is 83.3%. From the results, it is understood that the initial charge/discharge efficiency in Example 4 is high as compared to Comparative Example 4 in which the second layers 3a (Si) were formed by vacuum deposition. Besides, with the third layers 4a composed of lithium layers, the triple-layer negative electrode achieves higher charge/discharge efficiency than does the double-layer negative electrode in Example 1.

Assuming that discharge capacity for 1 cycle, expressed as a percentage, is 100%, the ratio of discharge capacity for 500 cycles thereto (C500/C1 discharge capacity ratio) exceeds 80%, that is, the discharge capacity is maintained at over 80% of the initial capacity even after the 500th cycle, and is far better than that of Comparative Example 4 (55.8%). One conceivable reason why Example 4 achieved better charge/discharge efficiency and cycle characteristics as compared to Comparative Example 4 is because, in Example 4, the binder (PVDF) which was present in the first layers 2a was not damaged by heat, and therefore, a deterioration in adhesion to the collector and decomposition of the binder itself were prevented. Another conceivable reason is that the second layers 3a adhered firmly to the first layers 2a by the adhesive action of the binder contained in the respective first layers 2a and second layers 3a and did not easily flake off, and separation and pulverization due to expansion and contraction were suppressed.

In regard to the net film-forming time (the time required for both side coating), it took about 2.7 hours to form the second layers 3a over the copper foil of 2000 m long. This is much less than the film-forming time (the time required for both side deposition: 67 hours) for the second layers in Comparative Example 4.

The evaluation results in Example 4 proves that the secondary battery provided with the negative electrode according to the present invention permits substantial reductions in the time taken to produce the negative electrodes in mass production and achieves high initial charge/discharge efficiency with stable cycle characteristics.

TABLE 3

| | Example 4 | Example 5 | Example 6 |
|---|---|---|---|
| Initial Charge Capacity | 1.108 Ah | 1.185 Ah | 1.055 Ah |
| Initial Discharge Capacity | 1.040 Ah | 1.120 Ah | 0.973 Ah |

### EXAMPLE 5

This Example illustrates an example of the negative electrode having a triple-layer construction (FIG. 2, FIG. 6), in which third layers 4a being Li layers are additionally formed on the respective second layers 3a in the construction of the negative electrode described in Example 2. The collector, first layers 2a and second layers 3a were produced from the same materials and in the same manners as in Example 2, respectively.

Copper foil, on which there had been formed up to the second layers 3a of negative electrodes, was set in the vacuum deposition device described in Comparative Example 1, and metal Li was placed as the evaporation source. After that, Li layers or the third layers 4a of 2 μm were formed over the negative electrode layers on the copper foil at a traveling deposition rate of 12 μm•m/min (FIG. 6).

Test results are shown in Table 3. The initial charge/discharge efficiency in Example 5 is 94.5%, while that in Comparative Example 5 is 85.5%. From the results, it is understood that the initial charge/discharge efficiency in Example 5 is high as compared to Comparative Example 5 in which the second layers 3a (Li:Si) were formed by vacuum deposition. Besides, with the third layers 4a composed of lithium layers, the triple-layer negative electrode achieves higher charge/discharge efficiency than does the double-layer negative electrode in Example 2.

Assuming that discharge capacity for 1 cycle, expressed as a percentage, is 100%, the ratio of discharge capacity for 500 cycles thereto (C500/C1 discharge capacity ratio) exceeds 80%, that is, the discharge capacity is maintained at over 80% of the initial capacity even after the 500th cycle, and is far better than that of Comparative Example 5 (59.4%). One conceivable reason why Example 5 achieved better charge/discharge efficiency and cycle characteristics as compared to Comparative Example 5 is because, in Example 5, the binder (PVDF) which was present in the first layers 2a was not damaged by heat, and therefore, a deterioration in adhesion to the collector and decomposition of the binder itself were prevented. Another conceivable reason is that the second layers 3a adhered firmly to the first layers 2a by the adhesive action of the binder contained in the respective first layers 2a and second layers 3a and did not easily flake off, and separation and pulverization due to expansion and contraction were suppressed.

In regard to the net film-forming time (the time required for both side coating), it took about 2.7 hours to form the second layers 3a over the copper foil of 2000 m long. This is much less than the film-forming time (the time required for both side deposition: 67 hours) for the second layers in Comparative Example 5.

The evaluation results in Example 5 proves that the secondary battery provided with the negative electrode according to the present invention permits substantial reductions in the time taken to produce the negative electrodes in mass production and achieves high initial charge/discharge efficiency with stable cycle characteristics.

### EXAMPLE 6

This Example illustrates an example of the negative electrode having a triple-layer construction (FIG. 2, FIG. 6), in which third layers 4a being Li layers are additionally formed on the respective second layers 3a in the construction of the negative electrode described in Example 3. The collector, first layers 2a and second layers 3a were produced from the same materials and in the same manners as in Example 3, respectively.

Copper foil, on which there had been formed up to the second layers 3a of negative electrodes, was set in the vacuum deposition device described in Comparative Example 1, and metal Li was placed as the evaporation source. After that, Li layers or the third layers 4a of 2 μm were formed over the negative electrode layers on the copper foil at a traveling deposition rate of 12 μm•m/min (FIG. 6).

Test results are shown in Table 3. The initial charge/discharge efficiency in Example 6 is 92.3%, while that in Comparative Example 6 is 66.2%. From the results, it is understood that the initial charge/discharge efficiency in Example 6 is high as compared to Comparative Example 6 in which the second layers 3a (SiO_{X}) were formed by vacuum deposition. Besides, with the third layers 4a composed of lithium layers, the triple-layer negative electrode achieves higher charge/discharge efficiency than does the double-layer negative electrode in Example 3.

Assuming that discharge capacity for 1 cycle, expressed as a percentage, is 100%, the ratio of discharge capacity for 500 cycles thereto (C500/C1 discharge capacity ratio) exceeds 80%, that is, the discharge capacity is maintained at over 80% of the initial capacity even after the 500th cycle, and is far better than that of Comparative Example 6 (breakdown after the 230th cycle). One conceivable reason why Example 6 achieved better charge/discharge efficiency and cycle characteristics as compared to Comparative Example 6 is because, in Example 6, the binder (PVDF) which was present in the first layers 2a was not damaged by heat, and therefore, a deterioration in adhesion to the collector and decomposition of the binder itself were prevented. Another conceivable reason is that the second layers 3a adhered firmly to the first layers 2a by the adhesive action of the binder contained in the respective first layers 2a and second layers 3a and did not easily flake off, and separation and pulverization due to expansion and contraction were suppressed.

In regard to the net film-forming time (the time required for both side coating), it took about 2.7 hours to form the second layers 3a over the copper foil of 2000 m long. This is much less than the film-forming time (the time required for both side deposition: 67 hours) for the second layers in Comparative Example 6.

The evaluation results in the Example 6 proves that the secondary battery provided with the negative electrode according to the present invention permits substantial reductions in the time taken to produce the negative electrodes in mass production and achieves high initial charge/discharge efficiency with stable cycle characteristics.

### COMPARATIVE EXAMPLE 4

This Comparative Example illustrates an example of the negative electrode having a triple-layer construction (FIG. 2, FIG. 6), in which third layers 4a being Li layers are additionally formed on the respective second layers 3a in the construction of the negative electrode described in Comparative Example 1. The collector, first layers 2a and second layers 3a were produced from the same materials and in the same manners as in Comparative Example 1, respectively.

Copper foil, on which there had been formed up to the second layers 3a of negative electrodes, was set in the vacuum deposition device described in Comparative Example 1, and metal Li was placed as the evaporation source. After that, Li layers or the third layers 4a of 2 μm were formed over the negative electrode layers on the copper foil at a traveling deposition rate of 12 μm•m/min (FIG. 6).

Test results are shown in Table 4. Presumably, the reason why Comparative Example 4 provides inferior characteristics as compared to Example 4 is because the binder (PVDF) present in the first layers 2a was damaged by radiant heat on the occasion of vacuum deposition of the second layers 3a (Si), which caused a deterioration in adhesion to the collector and decomposition of the binder itself. In addition, the flaking and pulverization of the deposited Si layers are incriminated as other causes.

TABLE 4

| | Comparative | Comparative | Comparative |
|---|---|---|---|
| | Example 4 | Example 5 | Example 6 |
| Initial Charge | 0.889 Ah | 0.986 Ah | 0.855 Ah |
| Capacity | | | |
| Initial Discharge | 0.741 Ah | 0.845 Ah | 0.566 Ah |
| Capacity | | | |
| Initial Charge/ | 83.3% | 85.8% | 66.2% |
| Discharge Efficiency | | | |
| Discharge Capacity | 55.8% | 59.4% | breakdown after |
| Ratio (C500/C1) | | | 230 cycles |

### COMPARATIVE EXAMPLE 5

This Comparative Example illustrates an example of the negative electrode having a triple-layer construction (FIG. 2, FIG. 6), in which third layers 4a being Li layers are additionally formed on the respective second layers 3a in the construction of the negative electrode described in Comparative Example 2. The collector, first layers 2a and second layers 3a were produced from the same materials and in the same manners as in Comparative Example 2, respectively.

Copper foil, on which there had been formed up to the second layers 3a of negative electrodes, was set in the vacuum deposition device described in Comparative Example 1, and metal Li was placed as the evaporation source. After that, Li layers or the third layers 4a of 2 μm were formed over the negative electrode layers on the copper foil at a traveling deposition rate of 12 μm•m/min (FIG. 6).

Test results are shown in Table 4. Presumably, the reason why Comparative Example 5 provides inferior characteristics as compared to Example 5 is because the binder (PVDF) present in the first layers 2a was damaged by radiant heat on the occasion of vacuum deposition of the second layers 3a (Li:Si), which caused a deterioration in adhesion to the collector and decomposition of the binder itself. In addition, the flaking and pulverization of the deposited Li:Si layers are incriminated as other causes.

### COMPARATIVE EXAMPLE 6

This Comparative Example illustrates an example of the negative electrode having a triple-layer construction (FIG. 2, FIG. 6), in which third layers 4a being Li layers are additionally formed on the respective second layers 3a in the construction of the negative electrode described in Comparative Example 3.

The collector, first layers 2a and second layers 3a were produced from the same materials and in the same manners as in Comparative Example 3, respectively.

Copper foil, on which there had been formed up to the second layers 3a of negative electrodes, was set in the vacuum deposition device described in Comparative Example 1, and metal Li was placed as the evaporation source. After that, Li layers or the third layers 4a of 2 μm were formed over the negative electrode layers on the copper foil at a traveling deposition rate of 12 μm•m/min (FIG. 6).

Test results are shown in Table 4. Presumably, the reason why Comparative Example 6 provides inferior characteristics as compared to Example 6 is because the binder (PVDF) present in the first layers 2a was damaged by radiant heat on the occasion of vacuum deposition of the second layers 3a (SiO_{X}), which caused a deterioration in adhesion to the collector and decomposition of the binder itself. In addition, the flaking and pulverization of the deposited SiO_{X} layers are incriminated as other causes.

### EXAMPLE 7

This Example illustrates examples of triple-layer negative electrodes (FIG. 2, FIG. 6) which have essentially the same construction as described previously for the negative electrode in Example 4 except for differences in the average diameter of Si particles contained in the second layers 3a (thickness: 3 μm), on which the third layers 4a being Li layers (2 μm) are formed. The collector, first layers 2a and second layers 3a were produced in the same manner as in Example 1.

Copper foil, on which there had been formed up to the second layers 3a of negative electrodes, was set in the vacuum deposition device described in Comparative Example 1, and metal Li was placed as the evaporation source. After that, Li layers or the third layers 4a of 2 μm were formed over the negative electrode layers on the copper foil at a traveling deposition rate of 12 μm•m/min (FIG. 6).

Test results are shown in Table 5. In the case where the average diameter of Si particles contained in the second layers 3a is 2.4 μm or less (equal to or less than 80% of the thickness of the second layer 3a), the initial charge/discharge efficiency is high as over 90%. Besides, the discharge capacity ratio (C500/C1) is maintained at over 80% of the initial capacity even after the 500th cycle. On the other hand, in the case where the average diameter of Si particles contained in the second layers 3a is 2.5 μm or more (exceeds 80% of the thickness of the second layer 3a), the initial charge/discharge efficiency drops to less than 80%. Consequently, the batteries could not be discharged and recharged through 500 cycles due to a short circuit or a breakdown. In Example 7, when the average diameter of Si particles was 2.5 μm in or more (exceeded 80% of the thickness of the second layers 3a), there was a short circuit. Presumably, this is because irregularities in the surfaces of the second layers 3a were increased, which resulted in a short circuit to the positive electrode.

The evaluation results in Example 7 proves that, in the negative electrode for the secondary battery according to the present invention, the average diameter of active material (metal) particles contained in the second layers 3a should preferably not exceed 80% of the thickness of the second layers 3a.

TABLE 5

| | | | | | | | | | | | | | | | | |
|---|---|---|---|---|---|---|---|---|---|---|---|---|---|---|---|---|
| Average Particle | 0.8 | μm | 1.2 | μm | 2.0 | μm | 2.2 | μm | 2.4 | μm | 2.5 | μm | 2.6 | μm | 2.8 | μm |
| Diameter | | | | | | | | | | | | | | | | |
| Initial Charge | 1.108 | Ah | 1.102 | Ah | 1.088 | Ah | 1.082 | Ah | 1.074 | Ah | 1.025 | Ah | 0.997 | Ah | 0.928 | Ah |
| Capacity | | | | | | | | | | | | | | | | |
| Initial Discharge | 1.040 | Ah | 1.037 | Ah | 1.020 | Ah | 1.014 | Ah | 1.010 | Ah | 0.820 | Ah | 0.776 | Ah | 0.685 | Ah |
| Capacity | | | | | | | | | | | | | | | | |

| | | | | | | | | |
|---|---|---|---|---|---|---|---|---|
| Initial Charge/ | 93.9% | 93.6% | 92.5% | 91.5% | 90.9% | 80.0% | 77.8% | 73.8% |
| Discharge Efficiency | | | | | | | | |
| Discharge Capacity | 82.3% | 82.5% | 81.4% | 81.1% | 80.5% | short after | short after | short after |
| Ratio (C500/C1) | | | | | | 180 cycles | 120 cycles | 65 cycles |

### EXAMPLE 8

This Example illustrates examples of triple-layer negative electrodes (FIG. 2, FIG. 6) which have essentially the same construction as described previously for the negative electrode in Example 6 except for differences in the average diameter of SiO_{X} particles contained in the second layers 3a (thickness: 3 μm), on which the third layers 4a being Li layers (2 μm) are formed. The collector, first layers 2a and second layers 3a were produced in the same manner as in Example 7.

Copper foil, on which there had been formed up to the second layers 3a of negative electrodes, was set in the vacuum deposition device described in Comparative Example 1, and metal Li was placed as the evaporation source. After that, Li layers or the third layers 4a of 2 μm were formed over the negative electrode layers on the copper foil at a traveling deposition rate of 12 μm•m/min (FIG. 6).

Test results are shown in Table 6. In the case where the average diameter of SiO_{X} particles contained in the second layers 3a is 2.4 μm or less (equal to or less than 80% of the thickness of the second layer 3a), the initial charge/discharge efficiency is high as over 80%. Besides, the discharge capacity ratio (C500/C1) is maintained at over 88% of the initial capacity even after the 500th cycle. On the other hand, in the case where the average diameter of SiO_{X} particles contained in the second layers 3a is 2.5 μm or more (exceeds 80% of the thickness of the second layer 3a), the initial charge/discharge efficiency drops to less than 80%. Consequently, the batteries could not be discharged and recharged through 500 cycles due to a short circuit or a breakdown. In Example 8, when the average diameter of SiO_{X} particles was 2.5 μm or more (exceeded 80% of the thickness of the second layers 3a), there was a short circuit. Presumably, this is because irregularities in the surfaces of the second layers 3a were increased, which resulted in a short circuit to the positive electrode.

The evaluation results in Example 8 proves that, in the negative electrode for the secondary battery according to the present invention, the average diameter of active material (metal oxide) particles contained in the second layers 3a should preferably not exceed 80% of the thickness of the second layers 3a.

TABLE 6

| | | | | | | | | | | | | | | | | |
|---|---|---|---|---|---|---|---|---|---|---|---|---|---|---|---|---|
| Average Particle | 0.8 | μm | 1.2 | μm | 2.0 | μm | 2.2 | μm | 2.4 | μm | 2.5 | μm | 2.6 | μm | 2.8 | μm |
| Diameter | | | | | | | | | | | | | | | | |
| Initial Charge | 0.947 | Ah | 0.924 | Ah | 0.909 | Ah | 0.900 | Ah | 0.898 | Ah | 0.865 | Ah | 0.827 | Ah | 0.818 | Ah |
| Capacity | | | | | | | | | | | | | | | | |
| Initial Discharge | 0.862 | Ah | 0.828 | Ah | 0.804 | Ah | 0.795 | Ah | 0.793 | Ah | 0.682 | Ah | 0.645 | Ah | 0.628 | Ah |
| Capacity | | | | | | | | | | | | | | | | |

| | | | | | | | | |
|---|---|---|---|---|---|---|---|---|
| Initial Charge/ | 91.0% | 89.6% | 88.4% | 88.3% | 88.3% | 78.9% | 78.0% | 76.8% |
| Discharge Efficiency | | | | | | | | |
| Discharge Capacity | 83.5% | 82.4% | 81.1% | 81.1% | 80.5% | short after | short after | short after |
| Ratio (C500/C1) | | | | | | 280 cycles | 240 cycles | 200 cycles |

### INDUSTRIAL APPLICABILITY

As set forth hereinabove, the negative electrode according to the present invention has a construction in which one or more kinds of particles selected from metal particles, alloy particles and metal oxide particles are bound by a binder. Thereby, the second layer adheres firmly to the first layer, and the mechanical strength of a multilayer film is improved. Thus, it is possible to achieve high battery capacity while maintaining high charge/discharge efficiency and good cycle characteristics through a simple method.

Further, according to the negative electrode production method of the present invention, the second layer is formed by dispersing at least one kind of metal particles, alloy particles and metal oxide particles in a solution in which a binder is dissolved, and applying and drying the coating solution. Therefore, the binder and the like suffer less damage as compared to those of conventional multilayer negative electrodes produced by vacuum deposition. Thus, it is possible to realize a high-capacity secondary battery having a good cycle characteristic.

In accordance with the present invention, if the average diameter of the metal particles, alloy particles or metal oxide particles contained in the second layer is made equal to or less than 80% of the thickness of the second layer, film thickness control is facilitated, and it is possible to produce a secondary battery which does not show a short circuit. Furthermore, since the coating method is adopted to form the second layer of the negative electrode, film-forming speed is far higher than is possible using conventional vacuum film-forming methods. Thus, the time taken to produce the negative electrode can be significantly reduced.

1. A negative electrode for a secondary battery comprising a collector, at least one first layer largely composed of carbon, and at least one second layer largely composed of filmy material having lithium ion conductivity, which are laminated in this order, wherein the second layer is formed of one or more kinds of particles selected from metal particles, alloy particles and metal oxide particles being bound by a binder.

2. The negative electrode for a secondary battery claimed in claim 1, wherein the average diameter of the particles contained in the second layer is equal to or less than 80% of the thickness of the second layer.

3. The negative electrode for a secondary battery claimed in claim 1, wherein the metal particles contains one or more elements selected from a group of Si, Ge, Sn, In and Pb.

4. The negative electrode for a secondary battery claimed in claim 1, wherein the alloy particles contains one or more elements selected from a group of Si, Ge, Sn, In and Pb.

5. The negative electrode for a secondary battery claimed in claim 1, wherein the metal oxide particles contains one or more elements selected from a group of Si, Ge, Sn, In and Pb.

6. The negative electrode for a secondary battery claimed in claim 1, wherein the particles which form the second layer are mainly metal particles.

7. The negative electrode for a secondary battery claimed in claim 1, wherein the particles which form the second layer are mainly alloy particles.

8. The negative electrode for a secondary battery claimed in claim 1, wherein the particles which form the second layer are mainly metal oxide particles.

9. The negative electrode for a secondary battery claimed in claim 1, further comprising at least one third layer having lithium ion conductivity on the second layer.

10. The negative electrode for a secondary battery claimed in claim 1, wherein the first layer is formed of carbonaceous material being bound by a binder, and both the binders contained in the first layer and the second layer are fluorocarbon resin.

11. A secondary battery comprising at least the negative electrode for a secondary battery claimed in claim 1, a positive electrode capable of absorbing and emitting lithium ions, and an electrolytic solution present in between the negative electrode and the positive electrode.

12. A method for producing a negative electrode for a secondary battery comprising a collector, at least one first layer largely composed of carbon, and at least one second layer largely composed of filmy material having lithium ion conductivity, which are laminated in this order, comprising the steps of:
forming the first layer largely composed of carbon on the collector; and
forming the second layer by coating the first layer with paint that contains one or more kinds of particles selected from metal particles, alloy particles and metal oxide particles and a binder, which is then dried.

13. The method for producing a negative electrode for a secondary battery claimed in claim 12, wherein the average diameter of the particles contained in the second layer is equal to or less than 80% of the thickness of the second layer.

14. The method for producing a negative electrode for a secondary battery claimed in claim 12, wherein the metal particles contains one or more elements selected from a group of Si, Ge, Sn, In and Pb.

15. The method for producing a negative electrode for a secondary battery claimed in claim 12, wherein the alloy particles contains one or more elements selected from a group of Si, Ge, Sn, In and Pb.

16. The method for producing a negative electrode for a secondary battery claimed in claim 12, wherein the metal oxide particles contains one or more elements selected from a group of Si, Ge, Sn, In and Pb.

17. The method for producing a negative electrode for a secondary battery claimed in claim 12, wherein the particles which form the second layer are mainly metal particles.

18. The method for producing a negative electrode for a secondary battery claimed in claim 12, wherein the particles which form the second layer are mainly alloy particles.

19. The method for producing a negative electrode for a secondary battery claimed in claim 12, wherein the particles which form the second layer are mainly metal oxide particles.

20. The method for producing a negative electrode for a secondary battery claimed in claim 12, further comprising the step of forming at least one third layer having lithium ion conductivity on the second layer.

21. The method for producing a negative electrode for a secondary battery claimed in claim 20, wherein:
the first layer is formed by coating the surface of the collector with paint that contains carbonaceous material and a binder, which is then dried; and
both the binders contained in the first layer and the second layer are fluorocarbon resin.
